(19) United States
(12) Patent Application Publication
(10) Pub. No.: US 2021/0198530 A1
(43) Pub. Date: Jul. 1, 2021

(54) VEHICLE PNEUMATIC TYRE HAVING A NOISE ABSORBER AND ADHESIVE COMPOSITION FOR FIXING AT LEAST ONE NOISE ABSORBER TO A SURFACE OF A VEHICLE PNEUMATIC TYRE

(71) Applicant: Continental Reifen Deutschland GmbH, Hannover (DE)

(72) Inventors: Mikheil Doroshenko, Garbsen (DE); Andreas Tyburski, Ilsede (DE); Joe Guardalabene, Hannover (DE); Markus Dahlke, Wunstorf (DE); Daniel Mohr, Coesfeld (DE); Dean Kleinert, Hannover (DE); Sherry-Ann Tim Kee, Hannover (DE)

(73) Assignee: Continental Reifen Deutschland GmbH, Hannover (DE)

(21) Appl. No.: 16/610,159

(22) PCT Filed: Apr. 17, 2018
(86) PCT No.: PCT/EP2018/059698

§ 371 Date: Nov. 1, 2019

(30) Foreign Application Priority Data
May 5, 2017 (DE) 10 2017 207 596.1
Apr. 11, 2018 (DE) 10 2018 205 420.7

(51) Int. Cl. C09J 7/38; C09J 7/10; B60C 19/00

(52) U.S. Cl. CPC C09J 7/383; C09J 7/10; B60C 19/002; C09J 2407/00; C09J 2423/00; C09J 2409/00; C09J 2475/006

(57) ABSTRACT

A pneumatic vehicle tire including at least one sound absorber adhesively attached to the inner surface opposite the tread in the interior of said tire, wherein the at least one sound absorber adheres to an adhesive, and to an adhesive composition for securing at least one sound absorber to a surface of a pneumatic vehicle tire. The adhesive includes 10% to 80% by weight of at least one rubber, 11% to 80% by weight of at least one polyolefin and 2% to 20% by weight of at least one hydrocarbon resin. The adhesive has optimized flow characteristics and an optimized stickiness.

The invention relates to a pneumatic vehicle tire comprising at least one sound absorber adhesively attached to the inner surface opposite the tread in the interior of said tire, wherein the at least one sound absorber adheres to an adhesive, and to an adhesive composition for securing at least one sound absorber to a surface of a pneumatic vehicle tire.

A pneumatic vehicle tire of the abovementioned type is known from DE 10 2007 028932 A1 and WO 2015149959 A1. The sound absorber from DE 10 2007 028932 A1 is in the form of a foam ring and reduces the air vibration in the tire, thus resulting in an improvement of the sound characteristics in the vehicle. The foam ring is made of open-celled foam and is also referred to as an “interior absorber”. The sealant subsequently applied to the tire inside after the tire heating operation has two functions: It seals an unwanted puncture of the tire in the region of the tread when in the case of damage to the inner layer the viscous sealant flows into the site of the damage. In addition, the sealant simultaneously serves as an “adhesive” for securing the sound-absorbing foam ring.

The sealant may be based on polyurethane or a viscous mixture based on a crosslinked butyl rubber, a crosslinked polybutene or based on silicone.

US 2016/0001612 A1 discloses a sealant for securing a sound absorber, wherein the sealant contains 20% to 40% by weight of butyl rubber, 20% to 30% by weight of polybutene and 35% to 50% by weight of filler.

However it is costly and inconvenient to produce a sealant and use it as a securing means for the sound absorber if self-sealing properties are not required to a great extent, if at all. One challenge is that the chemical composition of the adhesive for securing the sound absorber must be compatible with the other tire components and in particular that a suitable flowability and a suitable stickiness of the adhesive must be ensured. The adhesive should in particular have a comparatively simple composition compared to the described sealants and have an optimized viscosity.

The present invention accordingly has for its object to provide a pneumatic vehicle tire comprising at least one sound absorber adhesively attached to the inner surface opposite the tread in the interior of said tire, wherein the sound absorber adheres to an adhesive which is comparatively simple and cost-effective to produce, wherein the adhesion of the sound absorber shall be ensured over the entire lifetime of the tire.

This object is achieved when the adhesive contains at least the following constituents:
10% to 80% by weight of at least one rubber and
11% to 80% by weight of at least one polyolefin and
2% to 20% by weight of at least one hydrocarbon resin.

Since the adhesive contains the recited substances in the recited amounts it has a comparatively simple composition, is compatible with the other tire components and in particular has an optimized viscosity and thus optimized flow characteristics coupled with very good stickiness. The adhesion of the at least one sound absorber in the pneumatic vehicle tire according to the invention is therefore ensured over the lifetime of the tire. The pneumatic vehicle tire according to the invention is produced in a comparatively simple and cost-effective manner.

In the context of the present invention “viscosity” is to be understood as meaning in particular complex viscosity (e.g. by means of a plate-plate rheometer at a particular temperature of interest) unless otherwise stated. In the context of the present invention a complex viscosity at comparatively high temperature is relevant, such as in particular at 120° C.

The present invention further provides an adhesive composition (adhesive for short) for securing at least one sound absorber on a surface of a pneumatic vehicle tire which contains at least the following constituents:
10% to 80% by weight of at least one rubber and
11% to 80% by weight of at least one polyolefin and
2% to 20% by weight of at least one hydrocarbon resin.

The surface of the pneumatic vehicle tire for which the adhesive is suitable may in principle be any desired surface to which a sound absorber may be secured for utilization over a relatively long period, in particular for a long durability in vehicle operation and the lifetime of the tire.

It is advantageous to attach the at least one sound absorber in the interior of the tire, namely as described hereinabove on the inner surface opposite the tread. The surface may have any desired size and follows the geometry and the dimensions of the sound absorber.

The sound absorber of the pneumatic vehicle tire according to the invention may in principle be any element or any combination of elements which in a pneumatic vehicle tire may be attached to the inner surface thereof by adhesion and which reduces/reduce the sound emissions of the tire in vehicle operation.

In a preferred embodiment the at least one sound absorber is at least one porous damping element. Porous materials especially have the advantage that in addition to sound absorption they also introduce into the tire an intrinsic weight that is not excessive and the rolling resistance properties of the tire are therefore not unnecessarily impaired.

The porous material from which the damping element is formed is for example selected from the group containing polyurethane, in particular polyether-based and/or polyester-based polyurethane foams having a density of 18 to 300 kg/m³, preferably 30 to 35 kg/m³, and a hardness of 6.5 kilopascals, polyesters having a density of 18 to 300 kg/m³ preferably 30 to 35 kg/m³, and a hardness of 6.5 kilopascals, polyethers, and also any porous, sound-absorbing material mixtures, for example glass or rock wool, loop-pile or deep-pile fabric or nonwovens or cork. Further possible porous materials which are suitable for utilization as a damping element are for example a melamine resin foam or a builder's foam.

It is particularly preferable when the sound absorber, preferably at least one porous damping element, contains at least one polyurethane. Polyurethane is particularly suitable on account of its specific density and further nature and also its availability.

In a particularly advantageous embodiment of the porous damping element is a sound-absorbing foam ring closed or open in the circumferential direction. Said ring ensures even sound absorption and the tire maintains its uniformity. The ring may be closed in the circumferential direction or be open in the form of a strip, wherein the ends of the strip may or may not be in contact or may also overlap. The foam of the foam ring is preferably an open-celled foam since said foam is best suited for absorbing sound.

It is particularly preferable when the sound absorber is a closed sound-absorbing foam ring made of polyurethane, particularly preferably a polyether-based polyurethane foam. Such foams are known to those skilled in the art.

The sound absorber(s) may moreover have any desired shape, for example individual elements in the shape of blocks, strips or the like, which may be combined with one another as desired.

The constituents of the adhesive are more particularly elucidated hereinbelow. All elucidations apply to the adhesive of the pneumatic vehicle tire according to the invention and to the adhesive composition according to the invention, i.e. the adhesive according to the invention for short.

According to the invention the adhesive contains the following constituents:
10% to 80% by weight of at least one rubber and
11% to 80% by weight of at least one polyolefin and
2% to 20% by weight of at least one hydrocarbon resin.

The rubber may in principle be any rubber known to those skilled in the art.

In the case where the adhesive contains 2 or more different rubbers the total amount is 10% to 80% by weight and the reported quantities are based on the total amount of rubbers present unless otherwise stated.

In a preferred embodiment of the invention at least one diene rubber is concerned. The adhesive thus preferably contains 10% to 80% by weight of at least one diene rubber.

The term diene rubbers is to be understood as meaning rubbers that are formed by polymerization or copolymerization of dienes and/or cycloalkenes and thus comprise C═C double bonds either in the main chain or in the side groups.

The at least one diene rubber is preferably selected from the group consisting of natural polyisoprene (natural rubber, NR), synthetic polyisoprene (IR), epoxidized polyisoprene, butadiene rubber (polybutadiene, BR), butadiene-isoprene rubber, solution-polymerized styrene-butadiene rubber (SSBR), emulsion-polymerized styrene-butadiene rubber (ESBR), styrene-isoprene rubber, liquid rubbers having a weight-average molecular weight Mw according to GPC of more than 20 000 g/mol, halobutyl rubber, polynorbornene, isoprene-isobutylene copolymer, ethylene-propylene-diene rubber, nitrile rubber, chloroprene rubber, acrylate rubber, fluororubber, silicone rubber, polysulfide rubber, epichlorohydrin rubber, styrene-isoprene-butadiene terpolymer, hydrogenated acrylonitrile butadiene rubber and hydrogenated styrene-butadiene rubber.

In one particularly advantageous embodiment of the invention the rubber is selected from the group consisting of natural rubber (NR), synthetic polyisoprene (IR), butadiene rubber (BR), styrene-butadiene rubber (SBR), butyl rubber (IIR) and halobutyl rubber. Such rubbers are used in component parts of vehicle tires and are therefore particularly compatible with the component parts adjoining the adhesive.

The butyl rubber may be any butyl rubber known to those skilled in the art. Butyl rubber in the adhesive has the advantage that it is compatible with the rubber of the inner layer of the vehicle tire and has a comparatively high airtightness. In addition, 10% to 80% by weight of at least one butyl rubber contributes to the adhesive having the viscosity suitable for the described application.

In one advantageous embodiment of the invention the adhesive according to the invention contains the following constituents:
10% to 50% by weight of at least one butyl rubber and
31% to 80% by weight of at least one polyolefin and
2% to 20% by weight of at least one hydrocarbon resin.

In a preferred embodiment of the invention the adhesive contains at least one butyl rubber in amounts of 20% to 40% by weight, particularly preferably 20% to 38% by weight, in turn particularly preferably 20% to 28% by weight, very particularly preferably 23% to 28% by weight. These preferred embodiments further optimize the viscosity and stickiness of the adhesive.

In a further preferred embodiment of the invention the amount of the at least one butyl rubber is 51% to 80% by weight.

At this point it is emphasized that the adhesive does not replace the typically present inner layer of the pneumatic vehicle tire. On the contrary the pneumatic vehicle tire according to the invention comprises all other components (i.e. tread, sidewall, carcass ply, belt, inner layer etc.) as are known in the prior art.

In a particularly preferred embodiment of the invention the pneumatic vehicle tire comprises an inner layer (inner liner) which contains at least one halobutyl rubber and/or at least one butyl rubber, wherein the adhesive containing the abovementioned constituents adheres in the tire interior to the surface of the inner layer oriented radially inward to secure the sound absorber.

In a further advantageous embodiment of the invention the adhesive contains 10% to 80% by weight of at least one rubber, wherein the rubber is selected from the group consisting of natural rubber (NR), synthetic polyisoprene (IR), butadiene rubber (BR), styrene-butadiene rubber (SBR) and halobutyl rubber.

In a preferred embodiment of the invention the amount of the at least one rubber is 30% to 60% by weight, preferably 40% to 55% by weight, particularly preferably 45% to 50% by weight.

In a further preferred embodiment of the invention the amount of the at least one rubber is up to 80% by weight, in particular 60% to 80% by weight.

In a further preferred embodiment of the invention the adhesive contains at least one butyl rubber and at least one rubber selected from the group consisting of natural rubber (NR), synthetic polyisoprene (IR), butadiene rubber (BR), styrene-butadiene rubber (SBR) and halobutyl rubber, wherein the total amount is 10% to 80% by weight.

Any desired quantity ratios of butyl rubber to other rubber are conceivable. In an advantageous development of the invention 50% to 99% by weight of the total amount of rubbers present are rubbers selected from the group consisting of natural rubber (NR), synthetic polyisoprene (IR), butadiene rubber (BR), styrene-butadiene rubber (SBR) and halobutyl rubber and 1% to 50% by weight of at least one butyl rubber.

According to the present invention the adhesive contains 11% to 80% by weight of at least one polyolefin. The amount of the at least one polyolefin is preferably 31% to 80% by weight, particularly preferably 35% to 70% by weight, in turn particularly preferably 35% to 60% by weight, very particularly preferably 35% to 57% by weight. Such amounts achieve optimal flow characteristics and optimal stickiness coupled with good produceability (processability) of the adhesive.

The at least one polyolefin preferably has a number-average of the molecular weight distribution Mn according to GPC of 0.1 to 5 kg/mol, particularly preferably 0.4 to 1.6 kg/mol, very particularly preferably 0.4 to 1.4 kg/mol, in turn preferably 1 to 1.4 kg/mol, in turn particularly preferably 1.1 to 1.4 kg/mol, for example 1.3 kg/mol. A polyolefin having the recited ranges for Mn is particularly suitable for affording an adhesive having the desired flowability coupled with strong stickiness. The at least one polyolefin is particularly preferably at least one polybutene.

Polybutene is particularly suitable for adjusting the desired properties of the adhesive. The abovementioned preferred, particularly preferred etc. number-averages of the molecular weight distribution Mn apply in particular to the at least one polybutene. Such polybutenes are commercially available.

In a particularly advantageous development of the invention the at least one polyolefin has a chlorine content of not more than 5 mg/kg, preferably not more than 3 mg/kg. This specification relates to mg of chlorine per kg of polyolefin. In a preferred embodiment of the invention the adhesive contains at least one polyolefin having a chlorine content of not more than 1.5 mg/kg, particularly preferably less than 1 mg/kg. The polyolefin is preferably a polybutene.

In a particularly preferred embodiment of the invention the adhesive therefore contains at least one polybutene having a chlorine content of not more than 5 mg/kg, preferably not more than 3 mg/kg, particularly preferably not more than 1 mg/kg. Suitable polybutenes, also known as polyisobutenes are for example known under the Glissopal® trade names from BASF. Glissopal® V-500, V-640 or V-190 are especially suitable here.

Such a (virtually) chlorine-free polybutene in particular allows a sound absorber made of foam, preferably polyurethane (PU), to be employed, wherein the chlorine-free polybutene is particularly compatible with the (PU) foam and few, if any, decomposition processes take place.

According to the invention the adhesive contains 2% to 20% by weight of at least one hydrocarbon resin. The amount of the at least one hydrocarbon resin is preferably 5% to 10% by weight, particularly preferably 5% to 8% by weight, very particularly preferably 5% to 6.5% by weight. Such preferred and particularly preferred amounts further optimize the stickiness and the viscosity of the adhesive.

It will be clear to those skilled in the art that hydrocarbon resins are polymers constructed from monomers, wherein the hydrocarbon resin is formally constructed from derivatives of the monomers by linkage of the monomers to one another.

The term “hydrocarbon resins” encompasses in the context of the present application resins comprising carbon atoms and hydrogen atoms and optionally heteroatoms, such as in particular oxygen atoms.

The hydrocarbon resin may be a homopolymer or a copolymer. In the present application the term “homopolymer” is to be understood as meaning a polymer which, according to Römpp Online (retrieved on Jan. 2, 2017, article last updated August 2008), “has been formed from monomers of only one type”.

In the context of the present invention “copolymer” is to be understood as meaning a polymer formed from a plurality of, i.e. two or more, different monomers. In the context of the present invention the hydrocarbon resin may therefore also be a copolymer of three different monomers for example.

The monomers may be any monomers of hydrocarbon resins that are known to those skilled in the art, such as aliphatic monomers, in particular aliphatic C₅ monomers, further cationically polymerizable unsaturated compounds containing aromatics and/or terpenes and/or alkenes and/or cycloalkenes. Preferred monomers are in particular C₅ and C₉ monomers.

The aromatics (aromatic monomers) may be for example alpha-methylstyrene and/or styrene and/or vinyltoluene and/or indene and/or coumarone and/or methylindene and/or methylcoumarone and/or phenol. The aromatic monomers are preferably alpha-methylstyrene and/or styrene and/or vinyltoluene and/or indene and/or coumarone and/or methylindene and/or methylcoumarone.

In a preferred embodiment of the invention the at least one hydrocarbon resin comprises no phenolic hydrocarbon resin, i.e. the at least one hydrocarbon resin is preferably not based on phenol as a monomer. In the case of a mixture of at least two hydrocarbon resins it is thus preferable when neither is based on phenol as a monomer. In a preferred embodiment of the invention the adhesive is accordingly free from phenol resins, i.e. contains 0% to 0.1% by weight, ideally 0% by weight, of phenol resins.

According to Römpp Online the term “olefins” is the “common term for acyclic and cyclic aliphatic hydrocarbons having one or more reactive C═C double bonds in the molecule, nowadays better referred to as alkenes or cycloalkenes, and in the broader sense is also a term for the substituted derivatives thereof . . . .” In the context of the present invention unsaturated terpenes, alkenes and cycloalkenes are thus encompassed by the umbrella term “olefins”.

The alkenes may be 1-butene and/or 2-butene and/or butadiene for example.

In a preferred embodiment of the invention the hydrocarbon resin is at least one aliphatic resin, i.e. a resin which contains no aromatic ring systems. Such a resin consists to an extent of 100% by weight of aliphatic monomers/derivatives thereof. In a further embodiment of the invention the resin consists to an extent of 10% to 99% by weight, preferably 50% to 99% by weight, particularly preferably 70% to 99% by weight, of aliphatic monomers and to an extent of 1% to 90% by weight, preferably 1% to 50% by weight, particularly preferably 1% to 30% by weight, of aromatic monomers.

In a particularly preferred embodiment of the invention the hydrocarbon resin is at least one resin constructed at least from C₅ monomers and known to those skilled in the art as so-called C₅ resin. This makes it possible to achieve particularly good properties of the adhesive, in particular optimized flow characteristics coupled with good stickiness. The advantages are apparent in particular compared to phenol resins (phenolic resins).

The aliphatic C₅ monomers may be monomers from the C₅ crude oil fraction, for example isoprene, and/or monomers of the terpenes and/or cycloolefins and/or olefins, for example pentene. The term “C₅” is to be understood as meaning that these monomers are constructed from five carbon atoms.

It is further known to those skilled in the art that apart from aliphatic monomers having five carbon atoms the C₅ crude oil fraction may also contain other aliphatic monomers (building blocks) having for example four carbon atoms, i.e. C₄ monomers, or six carbon atoms, C₆ monomers.

In an advantageous embodiment of the invention the adhesive contains

1% to 50% by weight of at least one filler which allows optimal adjustment of the viscosity of the adhesive. To this end the amount of the at least one filler is particularly preferably 1% to 35% by weight, in turn particularly preferably 5% to 35% by weight, very particularly preferably 5% to 20% by weight and especially particularly preferably 5% to 15% by weight, in turn especially particularly preferably 5% to 10% by weight, based on the total amount of adhesive. The filler may be any filler known to those skilled in the art, in particular reinforcing fillers, such as carbon black and/or silica, wherein precipitated silicas familiar as fillers for tire rubber mixtures are meant and preferred in particular.

Further reinforcing and non-reinforcing fillers, in particular fillers based on silicon oxide, such as silicates or sand, are also conceivable.

In the context of the present invention the further non-reinforcing fillers include aluminosilicates, sand, kaolin, chalk, starch, magnesium oxide, titanium dioxide or rubber gels and also fibers (for example aramid fibers, glass fibers, carbon fibers, cellulose fibers). Further optionally reinforcing fillers are for example graphite and graphenes and so-called “carbon-silica dual-phase fillers”.

In a preferred embodiment of the invention the filler comprises at least one carbon black. This has the advantage that the cohesion of the adhesive is increased and the stickiness of the adhesive during the production process is reduced. The stationarity and the tear properties of the adhesive are simultaneously improved. In the context of the present invention all carbon black types known to the skilled person are conceivable in principle.

In an advantageous embodiment of the invention a carbon black having an iodine adsorption number according to ASTM D 1510 of 20 to 180 g/kg, particularly preferably 30 to 140 g/kg, and a DBP number according to ASTM D 2414 of 30 to 200 ml/100 g, preferably 90 to 180 ml/100 g, particularly preferably 110 to 180 ml/100 g, is employed.

In a further preferred embodiment of the invention an N326-type carbon black is used. A mixture of two or more carbon blacks is also conceivable.

In a further preferred embodiment of the invention the filler comprises at least one silica. This achieves optimal reinforcement of the adhesive and allows for good viscosity control and adjustment. In addition, the use of at least one silica increases the cohesion of the adhesive and reduces the stickiness of the adhesive during the production process. The stationarity and the tear properties of the adhesive are simultaneously improved. A mixture of two or more silicas is also conceivable. The silicas may be the silicas known to those skilled in the art that are suitable as a filler for tire rubber mixtures. Employable silicas thus include for example not only those of the type Ultrasil® VN3 (trade name) from Evonik but also silicas having a relatively low BET surface area (such as for example Zeosil® 1115 or Zeosil® 1085 from Solvay) and highly dispersible silicas, so-called HD silicas (for example Zeosil® 1165 MP from Solvay).

Also conceivable and preferable is a mixture of the recited fillers, such as in particular at least one carbon black in combination with at least one silica, which likewise affords the recited advantages.

In a particularly advantageous embodiment of the invention the adhesive is free from peroxidic compounds, i.e. according to this embodiment it contains 0% to 0.001% by weight, ideally 0% by weight, of such compounds, wherein the reported quantity relates to each substance individually.

In a particularly advantageous embodiment of the invention the adhesive is free from vulcanization agents and metal oxides, i.e. according to this embodiment it contains 0% to 0.001% by weight, ideally 0% by weight, of such compounds, wherein the reported quantity relates to each substance individually.

It is thus particularly preferable when the adhesive does not contain any substances that would result in crosslinking of the adhesive and are present in sealants known from the prior art. Compared to sealants as a means of securing the adhesive thus has a relatively simple and cost-effective composition and also has an optimized viscosity.

Typical substances which are present only in the respective amounts, if at all, in this preferred embodiment of the invention are:
from 0% to 0.001% by weight of peroxides, for example dibenzoyl peroxide, and preferably also:
from 0% to 0.001% by weight of zinc oxide,
from 0% to 0.001% by weight of quinones, for example quinone dioxime,

The adhesive may further contain additional constituents such as in particular plasticizers, for example oil(s).

In a preferred embodiment of the invention the adhesive contains 0.2% to 12% by weight of at least one plasticizer, wherein it especially and preferably contains a mixture of two different plasticizers. The use of 0.2% to 12% by weight, preferably 2% to 6% by weight, of at least one plasticizer ensures good processability and a further optimized viscosity of the adhesive. The plasticizers may be any plasticizers known to those skilled in the art, in particular oils, such as in particular aromatic, naphthenic or paraffinic mineral oil plasticizers, for example MES (mild extraction solvate) or RAE (residual aromatic extract) or TDAE (treated distillate aromatic extract) or rubber-to-liquid oils (RTL) or biomass-to-liquid oils (BTL) preferably having a content of polycyclic aromatics of less than 3% by weight according to the method IP 346. Mineral oils are particularly preferred as plasticizers. When using mineral oil said oil is preferably selected from the group consisting of DAE (distilled aromatic extracts) and/or RAE (residual aromatic extracts) and/or TDAE (treated distilled aromatic extracts) and/or MES (mild extracted solvents) and/or naphthenic oils.

In a preferred embodiment of the invention the adhesive consists of butyl rubber, polyolefin, hydrocarbon resin, filler and plasticizer, wherein the above elucidations in respect of the type and amount of the respective substances apply. In a preferred embodiment of the invention the adhesive especially includes:
10% to 50% by weight of at least one butyl rubber and
31% to 80% by weight of at least one polyolefin and
2% to 20% by weight of at least one hydrocarbon resin and
1% to 50% by weight of at least one filler and
0.2% to 12% by weight of at least one plasticizer.

The recited constituents always sum to 100% by weight.

Such an adhesive is optimized in particular in respect of processability, flow characteristics and stationarity. Said adhesive further comprises an optimal stickiness on account of the composition.

In a further preferred embodiment of the invention the adhesive consists of rubber, polyolefin, hydrocarbon resin, filler and plasticizer, wherein the above elucidations in respect of the type and amount of the respective substances apply.

In a preferred embodiment of the invention the adhesive especially includes:
10% to 80% by weight of at least one rubber selected from the group consisting of natural rubber (NR), synthetic polyisoprene (IR), butadiene rubber (BR), styrene-butadiene rubber (SBR), butyl rubber (IIR) and halobutyl rubber and
11% to 80% by weight of at least one polyolefin and
2% to 20% by weight of at least one hydrocarbon resin and
1% to 50% by weight of at least one filler and
0.2% to 12% by weight of at least one plasticizer.

In a further preferred embodiment of the invention the adhesive includes rubber, polyolefin, hydrocarbon resin, filler and plasticizer, wherein the above elucidations in respect of the type and amount of the respective substances apply. In a preferred embodiment of the invention the adhesive especially includes:
10% to 80% by weight of at least one rubber selected from the group consisting of natural rubber (NR), synthetic polyisoprene (IR), butadiene rubber (BR), styrene-butadiene rubber (SBR) and halobutyl rubber and butyl rubber, wherein the proportion of the butyl rubber based on the total amount of rubbers present is 1% to 50% by weight and
11% to 80% by weight of at least one polyolefin and
2% to 20% by weight of at least one hydrocarbon resin and
1% to 50% by weight of at least one filler and
0.2% to 12% by weight of at least one plasticizer.

The adhesive is in particular produced by—preferably intensive—mixing of the substances, wherein this may be carried out in one or more mixing stages. Mixing apparatuses known to those skilled in the art, such as internal mixers and/or extruders may be used here. The mixing duration and mixing temperature may also be adjusted according to the composition and viscosity of the adhesive. The adhesive may also be produced in an extruder, preferably a twin-screw extruder, for example. The adhesive may conceivably also be mixed using solvents for—preferably temporary—reduction of viscosity.

The adhesive may be applied to the tire inner surface, in particular to the surface opposite the tread, by any means known to those skilled in the art. Preference is given to spray application or application with a high-pressure pump.

The adhesive is preferably applied in a film thickness (in the radial direction) of 0.05 to 10 mm, wherein variations in the axial direction are possible as a consequence of manufacture. The adhesive may be applied for full-surface coverage or only in certain regions.

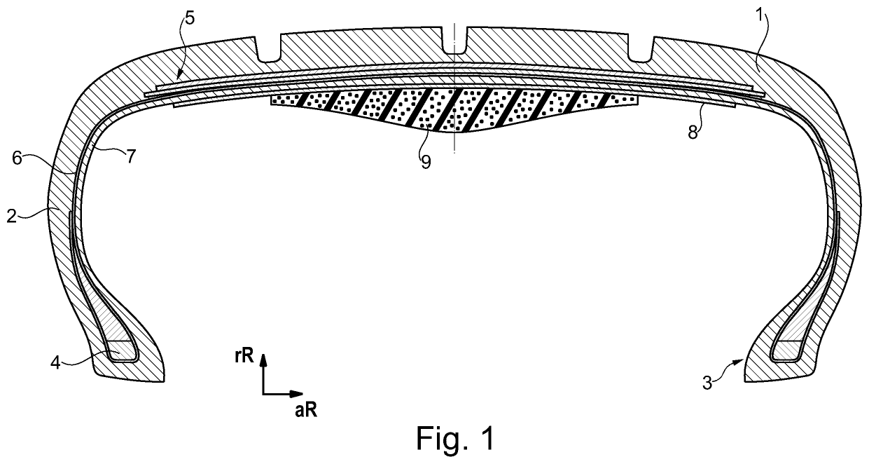

The invention shall be more particularly elucidated hereinbelow with reference to a working example. An example of an inventive pneumatic vehicle tire is shown in FIG. 1.

FIG. 1 depicts a cross section through a radial passenger motor vehicle tire having a profiled tread 1, sidewalls 2, bead regions 3, bead cores 4 and also a multi-ply belt bandage 5 and a carcass insert 6. On its inner surface, the tire is covered with an inner layer 7 of an airtight rubber compound. An adhesive 8 is subsequently applied (in the finished tire) to the inner surface of the inner layer 7 opposite the tread 1.

According to a first example the adhesive 8 consists of the following substances:
27.3% by weight of butyl rubber,
55.8% by weight of polybutene having an Mn of 1300 g/mol,
5.3% by weight of aliphatic hydrocarbon resin (C₅ resin),
8.4% by weight of N326 carbon black as a filler,
3.2% by weight of mineral oil plasticizer.

According to a further example the adhesive 8 contains the following substances:
48% by weight of at least one rubber selected from the group consisting of natural rubber (NR), synthetic polyisoprene (IR), butadiene rubber (BR), styrene-butadiene rubber (SBR), and halobutyl rubber,
35.1% by weight of polybutene having an Mn of 1300 g/mol,
5.3% by weight of aliphatic hydrocarbon resin (C₅ resin),
8.4% by weight of N326 carbon black as a filler,
3.2% by weight of mineral oil plasticizer.

This adhesive has for example a complex viscosity at 120° C. (0.02 Hz, frequency scanning, plate-plate rheometer) of 2700 Pas (pascal seconds) and is thus particularly optimized in respect of processability, flow characteristics, stationarity. Said adhesive further comprises an optimal stickiness on account of the composition.

Adhering to the adhesive 8 as sound absorber 9 is a sound-absorbing foam ring which is pressed into place immediately after application of the adhesive 8 as described hereinbelow. With respect to its sound-absorbing properties the sound-absorbing foam ring is matched to the tire cavity frequency. The sound absorber 9 in the form of a foam ring here has for example approximately an elongated triangle cross section that is symmetrical with respect to the tire equator.

The foam of the foam ring is an open-celled foam since said foam is best suited for absorbing sound. The foam comprises polyurethane for example.

The adhesive is introduced, for example by spray application, such that it covers at least the inner surface opposite the tread 1 or merely parts thereof. The tire may be rotated to optimally distribute the adhesive on the inner surface. The adhesive is further introduced in an amount such that the thickness/film thickness of the adhesive is between 0.05 mm and 10 mm. The adhesive shall be relatively liquid at least immediately after application to achieve optimal distribution of the adhesive over the surface and shall also be sticky. The prefabricated foam ring is introduced into the interior of the tire and pressed into place at this juncture. After introduction the foam ring adheres to the elastically deformable but very largely stationary adhesive 8.

### LIST OF REFERENCE NUMERALS

1 . . . Tread
2 . . . Sidewall
3 . . . Bead region
4 . . . Bead core
5 . . . Belt bandage
6 . . . Carcass insert
7 . . . Inner layer
8 . . . Adhesive
9 . . . Sound absorber
rR . . . Radial direction (arrowed direction pointing from radially inward to radially outward)
aR . . . Axial direction

1.-12. (canceled)

13. A pneumatic vehicle tire comprising at least one sound absorber adhesively attached to an inner surface opposite a tread and in an interior of the pneumatic vehicle tire, wherein the at least one sound absorber adheres to an adhesive, and wherein the adhesive comprises the following constituents:
10% to 80% by weight of at least one rubber;
11% to 80% by weight of at least one polyolefin; and,
2% to 20% by weight of at least one hydrocarbon resin.

14. The pneumatic vehicle tire as claimed in claim 13, wherein the at least one rubber is selected from the group consisting of natural rubber (NR), synthetic polyisoprene (IR), butadiene rubber (BR), styrene-butadiene rubber (SBR), butyl rubber (IIR) and halobutyl rubber.

15. The pneumatic vehicle tire as claimed in claim 13, wherein the adhesive contains 51% to 80% by weight of at least one butyl rubber (IIR).

16. The pneumatic vehicle tire as claimed in claim 13, wherein the adhesive contains 10% to 80% by weight of at least one rubber, wherein the rubber is selected from the group consisting of natural rubber (NR), synthetic polyisoprene (IR), butadiene rubber (BR), styrene-butadiene rubber (SBR) and halobutyl rubber.

17. The pneumatic vehicle tire as claimed in claim 16, wherein the at least one rubber is incorporated in an amount of from 30% to 60% by weight.

18. The pneumatic vehicle tire as claimed in claim 17, wherein the at least one rubber is incorporated in an amount of from 40% to 55% by weight.

19. The pneumatic vehicle tire as claimed in claim 18, wherein the at least one rubber is incorporated in an amount of from 45% to 50% by weight.

20. The pneumatic vehicle tire as claimed in claim 13, wherein the adhesive contains 1% to 35% by weight of at least one filler.

21. The pneumatic vehicle tire as claimed in claim 13, wherein the adhesive is free from vulcanization agents, metal oxides and peroxidic compounds.

22. The pneumatic vehicle tire as claimed in claim 13, wherein the at least one polyolefin is at least one polybutene.

23. The pneumatic vehicle tire as claimed in preceding claim 13, wherein the at least one sound absorber is at least one porous damping element.

24. The pneumatic vehicle tire as claimed in claim 23, wherein the porous damping element is a sound-absorbing foam ring closed or open in a circumferential direction of the pneumatic vehicle tire.

25. The pneumatic vehicle tire as claimed in claim 13, wherein the sound absorber comprises at least one polyurethane foam.

26. The pneumatic vehicle tire as claimed in claim 13, wherein the at least one hydrocarbon resin is incorporated in an amount of from 5% to 8% by weight.

27. The pneumatic vehicle tire as claimed in claim 13, wherein the at least one hydrocarbon resin is incorporated in an amount of from 5% to 6.5% by weight.

28. The pneumatic vehicle tire as claimed in claim 13, wherein the adhesive has a thickness in a radial direction of from 0.05 mm to 10 mm.

29. The pneumatic vehicle tire as claimed in claim 13, wherein the adhesive further comprises from 0.2% to 12% by weight of at least one plasticizer.

30. The pneumatic vehicle tire as claimed in claim 29, wherein at least one plasticizer is incorporated in an amount of from 2% to 6% by weight.

31. The pneumatic vehicle tire as claimed in claim 13, wherein the sound absorber comprises a melamine resin foam.
